(19) United States
(12) Patent Application Publication
(10) Pub. No.: US 2024/0316799 A1
(43) Pub. Date: Sep. 26, 2024

(54) FILAMENT-BODY-INTEGRATED ACTUATOR, UNIT, AND ROBOT

(71) Applicant: FANUC CORPORATION, Yamanashi (JP)

(72) Inventor: Kazutaka Nakayama, Minamitsuru-gun, Yamanashi-ken (JP)

(21) Appl. No.: 18/257,753

(22) PCT Filed: Dec. 15, 2021
(86) PCT No.: PCT/JP2021/046234

§ 371 Date: Jan. 29, 2024

(30) Foreign Application Priority Data
Dec. 22, 2020 (JP) 2020-212469
Jun. 3, 2021 (JP) 2021-093801

(51) Int. Cl. B25J 19/00; B25J 9/12

(52) U.S. Cl. CPC B25J 19/0029; B25J 9/126

(57) ABSTRACT

A filament-body-integrated actuator (10) includes: a filament body (29) which penetrates and extends through the interior of the actuator; a first relay part (25) to which one end of the filament body is connected; a second relay part (26) to which another end of the filament body is connected; and a first fixing part (23) and a second fixing part (24) for fixing the filament body to the actuator between the first relay part and the second relay part. The length of the filament body between the first fixing part and the second fixing part is greater than the shortest distance between the first fixing part and the second fixing part.

### TECHNICAL FIELD

The present disclosure relates to an integral umbilical member type actuator and to a unit and robot including such an integral umbilical member type actuator.

### BACKGROUND ART

An industrial robot, in particular an articulated robot, includes at least one joint at which two links are connected with each other. The joint is provided with an actuator for driving the links. The joint requires at least a power line and signal line for driving the actuator. Further, a signal line, air line, high speed communication signal line, etc. for driving an end effector provided at the front end of the industrial robot are necessary. In this Description, these power line, air line, various signal lines, etc. will be referred to all together as an “umbilical member”.

An umbilical member is preferably housed at the insides of the links of the robot. PTL 1 (Japanese Unexamined Patent Publication No. 2017-159397) discloses umbilical members extending running through a hollow part of an actuator. Further, PTL 2 (Japanese Patent No. 5004020) discloses an umbilical members extending through the hollow parts of two adjoining joints with rotational axes arranged vertically to each other.

### CITATIONS LIST

### Patent Literature

PTL 1. Japanese Unexamined Patent Publication No. 2017-159397
PTL 2. Japanese Patent No. 5004020

### SUMMARY

### Technical Problem

However, at the time of maintenance, a user has to consider the positional relationship between the umbilical member and surrounding objects so as to determine the fastening positions of the umbilical member. This is complicated. If the actuator is operated to rotate and the umbilical member is twisted in a state where the umbilical member is fastened with no slack, stress acting in the length direction toward a center part of the actuator will act on the umbilical members. Due to this, there is a possibility of the umbilical member breaking.

For this reason, an integral umbilical member type actuator securing high reliability and long service life of the umbilical members without the user being concerned about breakage of the umbilical members while enabling easy assembly, reconfiguration, and maintenance and a unit and robot containing such an integral umbilical member type actuator have been desired.

### Solution to Problem

According to a first aspect of the present disclosure, there is provided an integral umbilical member type actuator comprising at least one umbilical members extending running through an inside of the actuator, at least one first junction part positioned at one end side of the actuator and being connected to one ends of the umbilical members, at least one second junction part positioned at the other end side of the actuator and being connected to the other ends of the umbilical members, a first fastening part fastening the umbilical members to the actuator between the first junction part and the second junction part, and a second fastening part fastening the umbilical members to the actuator, lengths of the umbilical members between the first fastening part and the second fastening part being made longer than a shortest distance between the first fastening part and the second fastening part.

### Advantageous Effects of Disclosure

In the first aspect, the umbilical members are fastened by the first fastening part and second fastening part with a predetermined slack, so at a predetermined angle of the output shaft, the same fastened state can always be reproduced, therefore a high reliability and long service life of the umbilical members can be secured. Furthermore, a user need only connect the first junction part and second junction part to other connectors, so a user no longer need be concerned about rotational motion causing excessive stress to act on the umbilical members making them break and worry about the layout, and assembly, reconfiguration, and maintenance become easy. Furthermore, it becomes possible to make umbilical members of junction portions between integral umbilical member type actuators immovable umbilical members since there is no torsion acting due to axial rotational motion.

The object, features, and advantages of the present disclosure will become clearer from the following explanation of the embodiments given with reference to the attached drawings:

### BRIEF DESCRIPTION OF THE DRAWINGS

FIG. 1A is a partial enlarged view of a robot provided with an integral umbilical member type actuator of the present disclosure.

FIG. 1B is a partial enlarged view of another robot provided with an integral umbilical member type actuator of the present disclosure.

FIG. 1C is a partial enlarged view of a robot provided with an integral umbilical member type actuator in a first embodiment.

FIG. 1D is a partial enlarged view of another robot provided with an integral umbilical member type actuator in the first embodiment.

FIG. 2 is a cross-sectional view of an integral umbilical member type actuator in the first embodiment.

FIG. 3A is a cross-sectional view of an integral umbilical member type actuator in a second embodiment.

FIG. 3B is a cross-sectional view of an actuator in the prior art.

FIG. 4A is a first view showing a relationship between an axial direction cross-section of a hollow part and a radial direction cross-section at one end of a hollow part.

FIG. 4B is a second view showing a relationship between an axial direction cross-section of a hollow part and a radial direction cross-section at one end of a hollow part.

FIG. 5A is a cross-sectional view of an integral umbilical member type actuator in a third embodiment.

FIG. 5B is a cross-sectional view of another integral umbilical member type actuator in the third embodiment.

FIG. 5C is a cross-sectional view of still another integral umbilical member type actuator in the third embodiment.

FIG. 5D is a see through view of an AGV at which a robot is arranged.

FIG. 6A is a cross-sectional view of another integral umbilical member type actuator in a fourth embodiment.

FIG. 6B is a cross-sectional view of another integral umbilical member type actuator in the fourth embodiment.

FIG. 6C is a cross-sectional view of still another integral umbilical member type actuator in the fourth embodiment.

FIG. 7A is a cross-sectional view of an integral umbilical member type actuator in a fifth embodiment.

FIG. 7B is a cross-sectional view of another integral umbilical member type actuator in the fifth embodiment.

FIG. 8A is a first enlarged view of a junction part.

FIG. 8B is a second enlarged view of a junction part.

FIG. 8C is a third enlarged view of a junction part.

FIG. 9A is a cross-sectional view of a unit including an integral umbilical member type actuator in another embodiment.

FIG. 9B is another cross-sectional view of a unit including an integral umbilical member type actuator in another embodiment.

### DETAILED DESCRIPTION

Below, embodiments of the present disclosure will be explained with reference to the attached drawings. Throughout the figures, corresponding constituent elements will generally be assigned common reference notations.

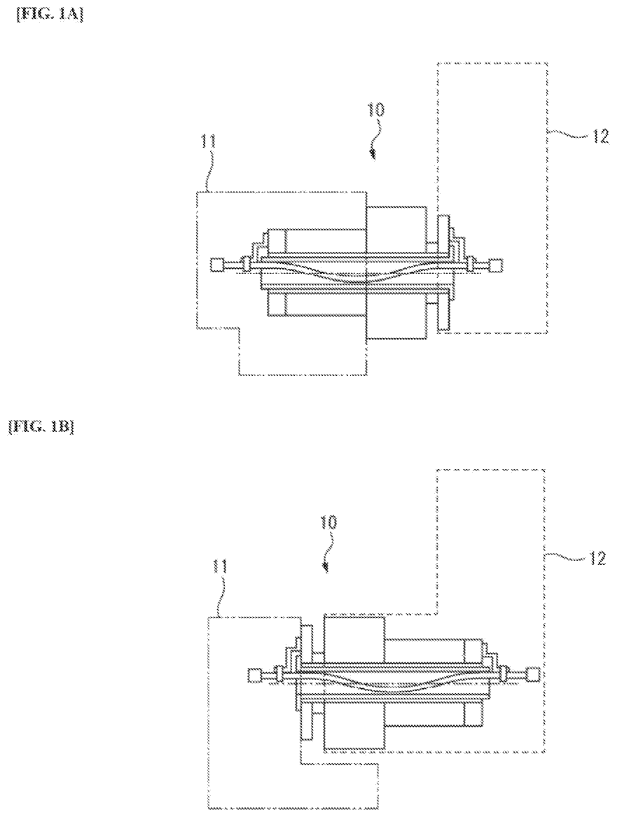

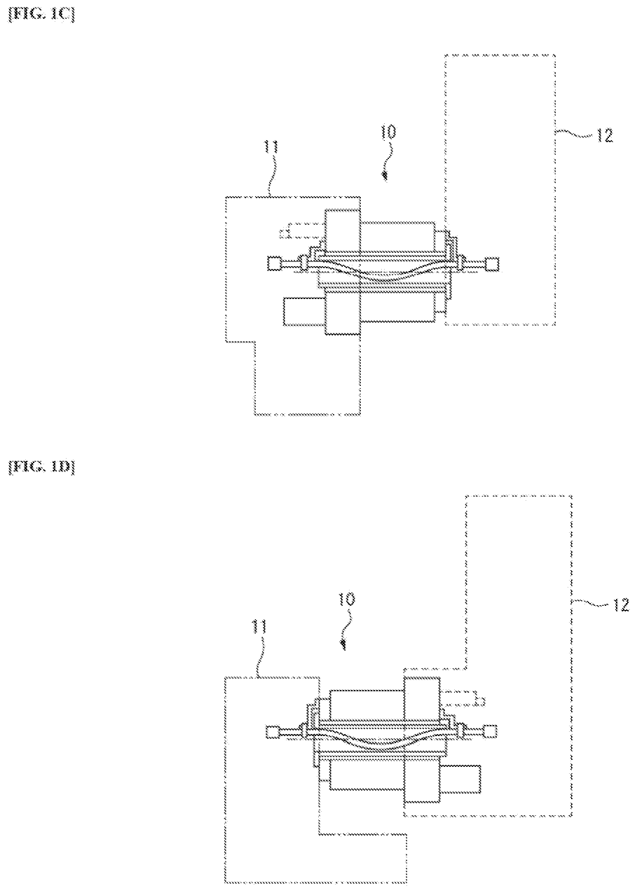

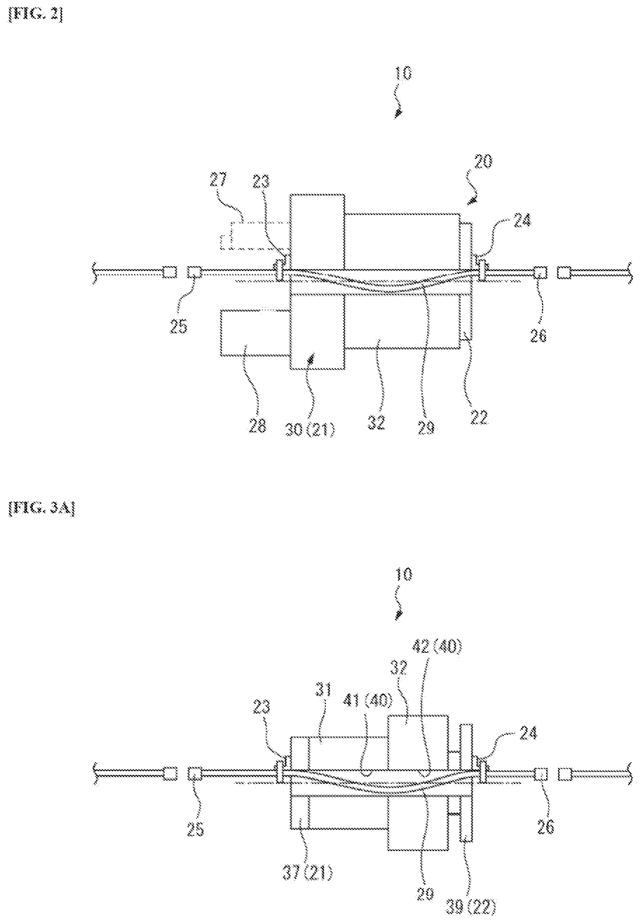

FIG. 1A is a partial enlarged view of a robot provided with an integral umbilical member type actuator of the present disclosure. FIG. 1A shows one joint axis of a robot 1 (explained later). The joint axis is driven by an integral umbilical member type actuator 10.

As shown in FIG. 1A, one end side of the integral umbilical member type actuator 10 has a first link 11 attached to it while the other side has a second link 12 attached to it. These first link 11 and second link 12 correspond to any two adjoining arm parts of the robot 1.

Further, as shown in FIG. 1B of a partial enlarged view of a robot provided with an integral umbilical member type actuator of the present disclosure, the first link 11 and second link 12 may also be attached at the respectively opposite sides. Further, the shapes of the first link 11 and second link 12 may also be different from each other. Furthermore, the first link 11 and second link 12 are not limited to the illustrated shapes. In any case, if driving the integral umbilical member type actuator 10, the second link 12 pivots with respect to the first link 11. In the later explained figures, for simplification, illustration of the first link 11 and second link 12 may be omitted.

FIG. 2 is a cross-sectional view of an integral umbilical member type actuator in the first embodiment. An actuator body 20 of the integral umbilical member type actuator 10 includes a solid drive motor 28, hollow speed reducer 32, and motor adapter 30.

FIG. 1C and FIG. 1D show examples of assembly of the integral umbilical member type actuator of FIG. 2 into a robot in the same way as FIG. 1A and FIG. 1B. The motor adapter 30 of the integral umbilical member type actuator 10 operates integrally with the first link 11, while the output shaft of the integral umbilical member type actuator body 10 rotates integrally with the second link 12. Note that, the outer circumferential case of the hollow speed reducer 32 may also be directly attached to the first link 11. A structure where the motor adapter 30 of the integral umbilical member type actuator 10 operates integrally with the second link 12 while the output shaft of the integral umbilical member type actuator body 10 rotates integrally with the first link 11 is also possible.

The actuator body 20 may also be comprised of only a direct drive motor. Note that, in FIG. 2, a solid drive motor 28 for driving the actuator body 20 configured as a speed reducer is attached to the motor adapter 30. Note that, if using a direct drive motor, it becomes possible to directly drive the links 11, 12 without using the hollow speed reducer 32, so the positioning precision of the robot 1 is improved.

As shown in FIG. 2, the umbilical member 29 extending along the output shaft of the hollow speed reducer 32 run through the inside of the actuator body 20. The umbilical member 29 preferably runs through the hollow part at the inside of the actuator body 20. Alternatively, liquid proof structure or oil proof structure umbilical member 29 may pass through the inside of a lubrication oil passage of the actuator body 20. The umbilical member 29 includes at least one of a power line and signal line for the actuator body 20 and a power line, signal line, and air line for control of a tool attached to the front end of the robot 1 (not shown). Furthermore, the umbilical member 29 may include conduits for relaying data information of sensors output from the later explained servo driver 27, data information of sensors input to the servo driver 27, and data of one adjoining axis before and one axis after the axis of the integral umbilical member type actuator 10 (below, referred to as “that axis”), for example, supplying a signal or air for driving a hand of a robot wrist part (not shown), position information data of one adjoining axis before and one axis after that axis input to the servo driver 27, data of torque sensors of axes other than that axis, and alarm information generated at axes other than that axis. Further, as signal lines, optical fiber communication cables may be used. The optical fiber communication cables include quartz glass based optical fibers and acrylic resin and other plastic optical fibers etc.

Note that, in FIG. 2, the solid drive motor 28 is attached to part of the motor adapter 30. In other words, the solid drive motor 28 is arranged offset from the rotational axes of the moving members. In this way, an embodiment in which the speed reducer has a hollow structure, but the drive motor does not have a hollow structure or, as mentioned later, an embodiment in which both the speed reducer and drive motor have hollow structures may be considered. If the actuator body 20 is comprised of only a direct drive motor, the direct drive motor itself desirably has a hollow structure.

As illustrated, one end of the umbilical member 29 is connected to a first junction part 25 positioned at the motor adapter 30 side. Further, between the first junction part 25 and actuator body 20, the umbilical members 29 is fastened by the first fastening part 23 to the motor adapter 30. Similarly, the other end of the umbilical member 29 is connected to the second junction part 26 positioned at the hollow speed reducer 32 side. Further, between the second junction part 26 and actuator body 20, the umbilical member 29 is fastened by the second fastening part 24 to the output shaft of the hollow speed reducer 32. Note that, a plurality of first junction parts 25 and a plurality of second junction parts 26 may also be provided.

The umbilical member 29 may include a plurality of line members. In such a case, the first fastening part 23 and second fastening part 24 desirably fasten the plurality of line members at predetermined positions. Rather than fastening a single large bundle of umbilical members, fastening them divided into smaller numbers into several bundles enables the bundles of smaller numbers of umbilical members to be ruggedly fastened, so even if tensile stress acts on the length directions of the umbilical members due to twisting motion, the umbilical members can be kept from moving. Of course, as the fastening parts, as structures due to which umbilical members will not move due to twisting motion, the bundles of umbilical members may be fastened overall. Due to this, if the integral umbilical member type actuator 10 operates to rotate by exactly a predetermined angle from a predetermined position, the twisted states of the individual line members of the umbilical member 29 becomes constantly the same. In other words, when the integral umbilical member type actuator 10 operates to rotate by exactly a predetermined angle from a predetermined position and then operates to rotate in the opposite direction to the original predetermined position, the situation will not arise where some of the line members return to the predetermined position, but other line members do not return to the predetermined position. By employing such a first fastening part 23 and second fastening part 24, a longer service life of the umbilical members 29 can be realized.

As will be understood from FIG. 2, the first fastening part 23 and second fastening part 24 are preferably located at positions away from the center of the actuator body 20. Further, the first fastening part 23 and second fastening part 24 are substantially L-shape members in the present embodiment, but may also be other shapes.

The first junction part 25 and second junction part 26 of the actuator body 20 are for example connectors and are connected to other junction parts. Further, as will be understood from FIG. 2, when the first link 11 and second link 12 are coupled with the integral umbilical member type actuator 10, the first junction part 25 and second junction part 26 may respectively be accommodated at the insides of the first link 11 and second link 12 and may be assembled with the outer circumferential case of the motor adapter 30 or hollow speed reducer 32.

In this way, in the present disclosure, the umbilical member 29 is respectively fastened by the first fastening part 23 and second fastening part 24 to the fastened part 21 (in FIG. 2, motor adapter 30 and in other figures, the hollow brake 37) and the moving part 22 which can rotate relative to the fastened part 21 and to which the second link 12 is attached (in FIG. 2, the output part 22 of the hollow speed reducer 32 and in other figures, the torque sensor 39). Further, the umbilical member 29 has sufficient slack between the first fastening part 23 and second fastening part 24. In other words, the length of the umbilical member 29 between the first fastening part 23 and second fastening part 24 is longer than the shortest distance between the first fastening part 23 and second fastening part 24.

Therefore, in the present disclosure, the umbilical member 29 engages in twisting motion only between the first fastening part 23 and second fastening part 24. Due to this, axial direction rotation is absorbed. For this reason, in the present disclosure, it is possible to provide a highly reliable integral umbilical member type actuator 10 which operates completely with just twisting motion of the umbilical member 29 and in which no bending motion occurs. Furthermore, a user need only connect the first junction part 25 and second junction part 26 to other connectors, so a user no longer need be concerned about breakage due to stress caused by twisting motion and worry about slack of the umbilical member. Assembly, reconfiguration, and maintenance become easy. Of course, while not shown, the structure may also be made one where the first fastening part 23 and second fastening part 24 are provided in a space at the outside of the hollow part 40 in a direction intersecting the rotational axis at a portion where the umbilical members are pulled out from the hollow part 40 so that the umbilical member is bent in addition to being twisted.

FIG. 3A is a cross-sectional view of an integral umbilical member type actuator in a second embodiment. The integral umbilical member type actuator 10 shown in FIG. 3A includes a hollow motor 31 and a hollow speed reducer 32 coaxially coupled with the hollow motor 31. The hollow motor 31 is provided with a hollow brake 37. Furthermore, between the hollow speed reducer 32 and second link 12, a torque sensor 39 is provided for detecting the force acting on the output shaft of the integral umbilical member type actuator 10. As illustrated, the hollow part 41 of the hollow motor 31 and the hollow part 42 of the hollow speed reducer 32 preferably have mutually common inside diameters. Due to this, there is no longer a step difference between the hollow part 41 of the hollow motor 31 and the hollow part 42 of the hollow speed reducer 32 and the umbilical member 29 can be kept from being damaged. Below, the hollow part 41 of the hollow motor 31 and the hollow part 42 of the hollow speed reducer 32 will sometimes together be referred to as the “hollow parts 40”.

As shown in FIG. 3A, the umbilical member 29 is preferably arranged so as to at least partially run on a center axis of the actuator 10 or hollow part 40 or on another line parallel to the center axis at the two ends of the hollow part 40. The umbilical member 29 tends to more easily break the closer the twisting to the rotational center axis, so there is a possibility of further lengthening the service life of the umbilical member 29 by fastening the umbilical member 29 at positions away from the center axis.

Alternatively, the umbilical member 29 may also be arranged on the center axis of the hollow part 40 at the two ends of the actuator 10 or hollow part 40. In this case, it is possible to secure a large extra margin for slack of the umbilical member 29 inside the hollow parts 40.

FIG. 3B is a cross-sectional view of an actuator in the prior art. In FIG. 3B, the solid drive motor 28′ is attached to a corner part of one end of the actuator body 20′. If attaching a larger drive motor 28′ and if using a small sized actuator body 20′, part of the drive motor 28′ partially closes the hollow part at one end of the actuator body 20′. In such a case, to keep the umbilical member 29′ from contacting part of the drive motor 28′, it is necessary to make the umbilical member 29′ bends. As a result, the umbilical member 29′ is subjected to not only twisting, but also bending, so there is the problem that the service life of the umbilical member easily falls.

However, in FIG. 3A, the hollow motor 31 is enclosed inside of the integral umbilical member type actuator 10, so there is no need to attach the drive motor 28′ at one end of the integral umbilical member type actuator 10. In other words, the drive motor 28′ never partially closes the hollow part 40 of the integral umbilical member type actuator 10, so the above-mentioned problem can be avoided.

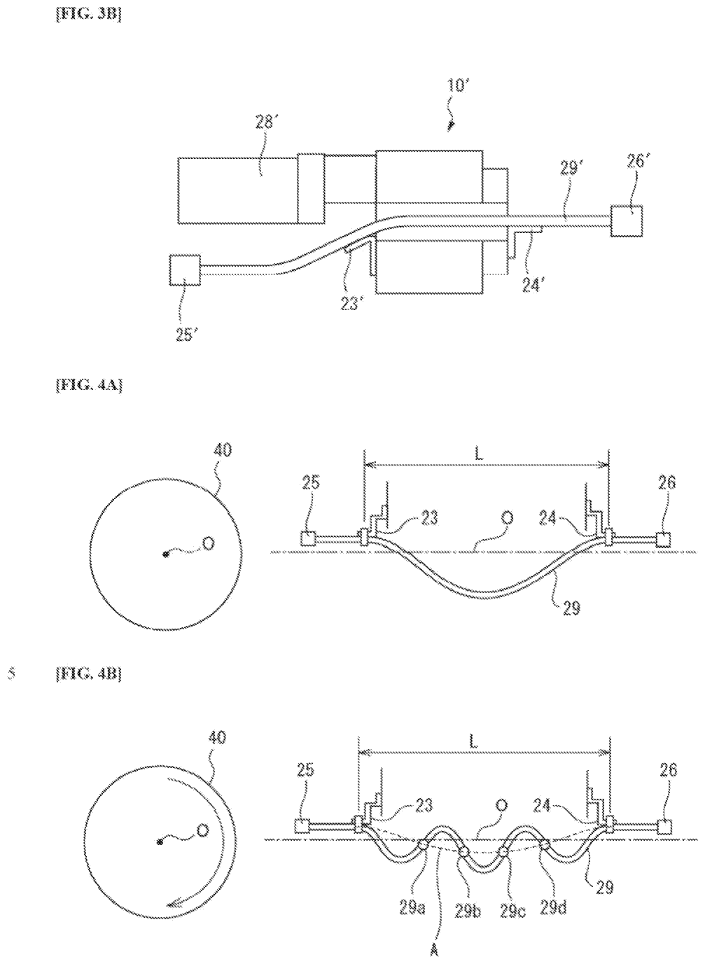

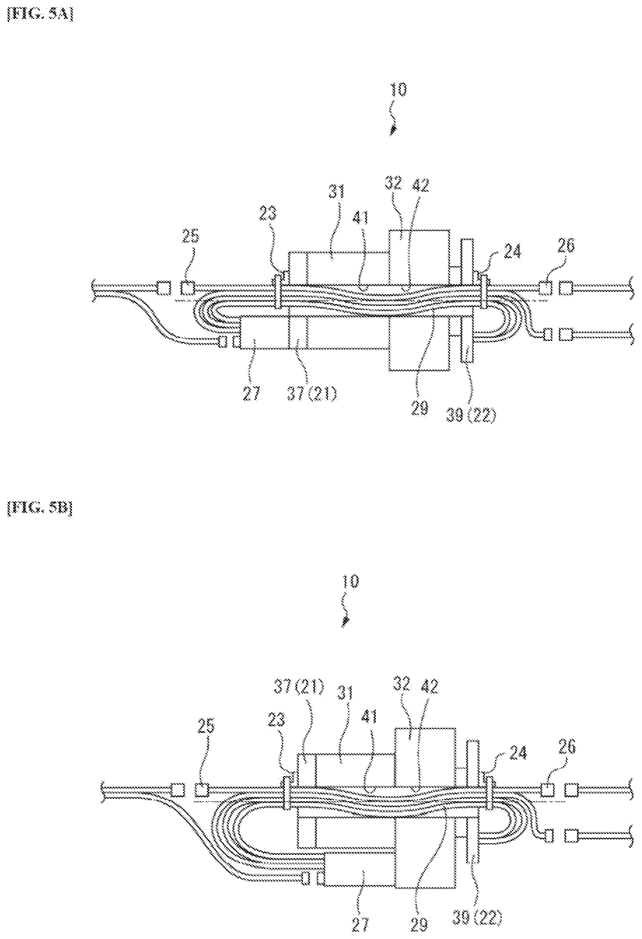

FIG. 4A and FIG. 4B are views showing a relationship between an axial direction cross-section of a hollow part and a radial direction cross-section at one end of a hollow part. FIG. 4A to FIG. 4B respectively show partial axial direction cross-sections of the hollow part 40 at the right sides and ends of the hollow part 40 at the left sides.

The umbilical member 29 includes a plurality of line members, but for facilitating the explanation, only a single umbilical member 29 is illustrated. The case of a single umbilical member 29 is also included in the scope of the present disclosure. Furthermore, the contents of FIG. 4A to FIG. 4B also apply to the other embodiments as well.

In FIG. 4A, the integral umbilical member type actuator 10 has not operated to rotate at its initial position. As a result, the umbilical member 29 is not twisted. The first fastening part 23 and second fastening part 24 are respectively arranged in the vicinities of the end parts of the hollow part 40, so the distance L between the first fastening part 23 and second fastening part 24 is approximately equal to the length of the hollow part 40 in the axial direction. In FIG. 4A, the length of the umbilical member 29 between the first fastening part 23 and second fastening part 24 is longer than the shortest distance L between the first fastening part 23 and second fastening part 24. In other words, in FIG. 4A, the umbilical member 29 is slack between the two ends of the hollow part 40 and droop downward.

In FIG. 4B, it is assumed that the integral umbilical member type actuator 10 has operated to rotate clockwise to the maximum angle, for example, up to 180°. For this reason, the umbilical member 29 is twisted so as to form spirals. As a result, the umbilical member 29 is formed with pluralities of “twisted parts”.

The points 29a to 29d on the umbilical member 29 illustrated in FIG. 4B show the centers of gravity of the “twisted parts”. As will be understood from FIG. 4B, the curve A connecting the centers of gravity is partially positioned lower than the center axis O of the hollow part 40. Further, the length of the curve A is longer than the distance L between the first fastening part 23 and second fastening part 24.

In other words, in the present disclosure, even if the integral umbilical member type actuator 10 has rotated up to the maximum angle, the curve A is longer than the distance L between the first fastening part 23 and second fastening part 24 and there is an extra margin enabling natural slack due to gravity. It is preferable to form a state where no tensile stress acts in the length direction of the umbilical members.

In this way, the umbilical member 29 is fastened by the first fastening part 23 and second fastening part 24 given a predetermined slack. Further, the predetermined slack is set so that even when the integral umbilical member type actuator 10 has rotated to the maximum angle, the curve A connecting the centers of gravity of the “twisted parts” of the umbilical member 29 become longer than the distance L. For this reason, even when the integral umbilical member type actuator 10 has rotated to the maximum angle, the tension applied to the umbilical member 29 is kept to the minimum extent and the umbilical member 29 becomes harder to break. Therefore, high reliability and long service life of the umbilical member 29 can be secured. Furthermore, no torsion acts due to the axial rotation operation. The umbilical member of the junction portions between integral umbilical member type actuators, for example, junction use umbilical member stored in the links, can also be made immovable umbilical member. Further, as shown in FIG. 4A, if the umbilical member 29 is arranged to run above the center axis of the hollow part 40 at the two ends of the hollow part 40, it is possible to secure a large extra margin enabling slack of the umbilical member 29. Note that, it will be clear that a similar effect is obtained even in a case of rotational operation counterclockwise.

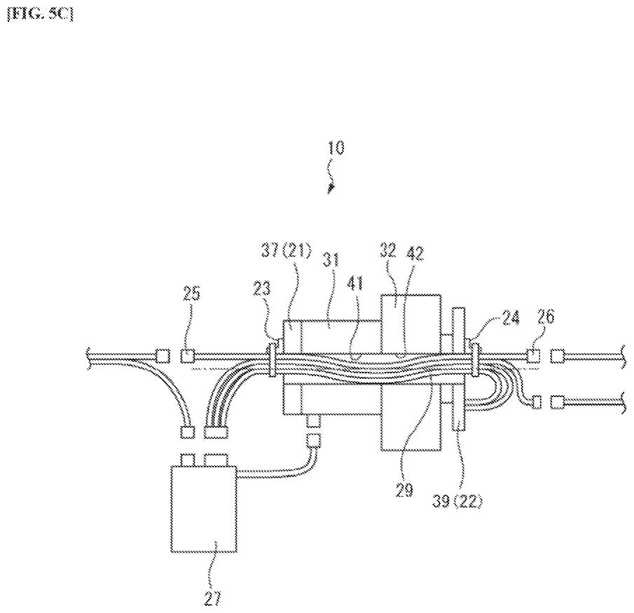

Further, in recent years, robots 1 provided with integral umbilical member type actuators 10 have sometimes been mounted in AGVs (automatic guided vehicles) (see FIG. 5D explained later). In such a case, it is desirable to use the battery of the AGV to drive the actuator 10, so a distributed servo driver should be attached to the actuator 10.

FIG. 5A is a cross-sectional view of an integral umbilical member type actuator in a third embodiment. In FIG. 5A, servo driver 27 for controlling the hollow motor 31 is attached to one end of the actuator 10. The servo driver 27 can include a microcomputer for control of the operation of an inverter for converting DC power to AC power and/or the hollow motor 31 for servo control of the hollow motor 31.

FIG. 5B is a cross-sectional view of another integral umbilical member type actuator in the third embodiment. The servo driver 27 shown in FIG. 5B is attached at the end face of the hollow speed reducer 32 at the opposite side from the second link 12. In this case, the actuator 10 as a whole is kept from becoming longer in the axial direction.

FIG. 5C is a cross-sectional view of still another integral umbilical member type actuator in the third embodiment. The servo driver 27 shown in FIG. 5C is made one attached to the first link 11 or the inside surface of a robot arm. Alternatively, the servo driver 27 may also be attached to another part arranged inside of a robot arm. Between the servo driver 27 and hollow motor 31, as shown in FIG. 5C, additional line members are connected for supplying power for driving the hollow motor 31 and for transfer of signals. Connectors may be provided at both of the servo driver 27 and hollow motor 31. Alternatively, one may be provided at just one of the same and something like a lead wire may be provided at the other. Further, the additional line members do not have to be movable umbilical members and do not have to be passed through a hollow hole of an integral type actuator.

In this way, the servo driver 27 is preferably mounted at the actuator 10 or its vicinity. Alternatively, the servo driver 27 itself may also be integral with the actuator 10. Similarly, in the first embodiment shown in FIG. 2, a similar servo driver 27 for driving the drive motor 28 may also be mounted at the actuator 10 or its vicinity. The servo driver 27 is sent a movement instruction by, for example, the industrial use Ethernet® or field bus or other such communication method enabling daisy chain connection. Further, if the servo driver 27 is an inverter, a DC link voltage is connected. Due to this, daisy chain connection becomes possible between the controller and servo driver 27 and between the servo driver 27 and another servo driver and wiring can be omitted. Umbilical members connecting these are used. In FIG. 2, only the servo driver 27 is shown by broken lines. Illustration of the umbilical members to be connected to the servo driver 27 is omitted. Furthermore, in the first embodiment, the servo driver 27 may also be made integral with the actuator 10. To keep the servo driver 27 from becoming high temperature, the surroundings of the servo driver 27 are preferably structured to not closely contact the surface of the actuator 10.

FIG. 5D is a see through view of an AGV at which a robot is arranged. Inside of the robot 1 shown in FIG. 5D, for example, the vertical articulated robot, a plurality of integral umbilical member type actuators 10 are provided. If as shown in FIG. 5A to FIG. 5C, the servo driver 27 is mounted at the actuator 10 or its vicinity, it is possible to use the DC battery of the AGV 2 provided with the robot 1 to control the servo driver 27 and drive the actuator 10. That is, it is no longer necessary to connect the servo driver 27 to an outside power source, so the AGV 2 can be made to move smoothly over a broad range.

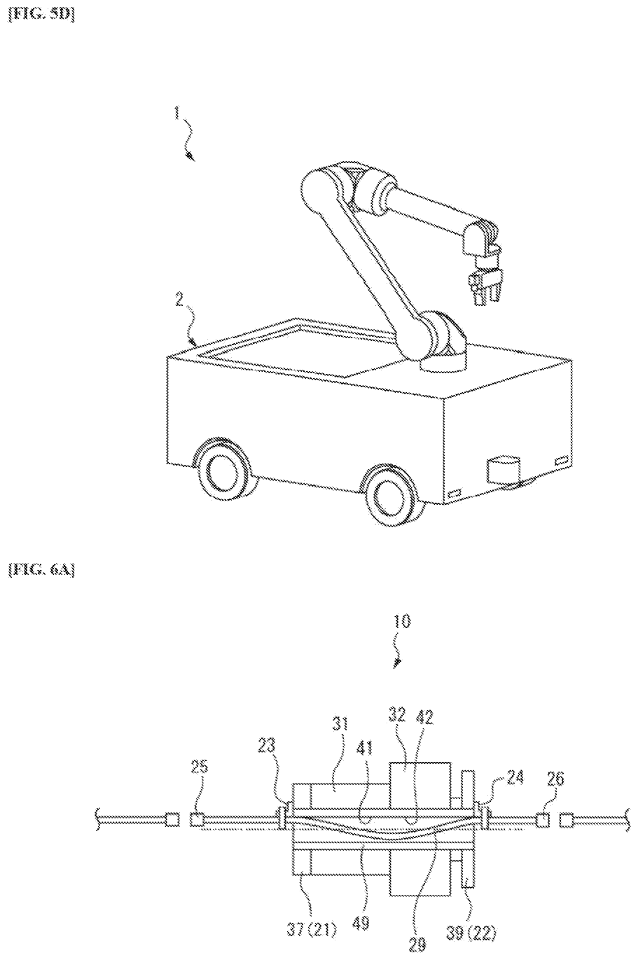

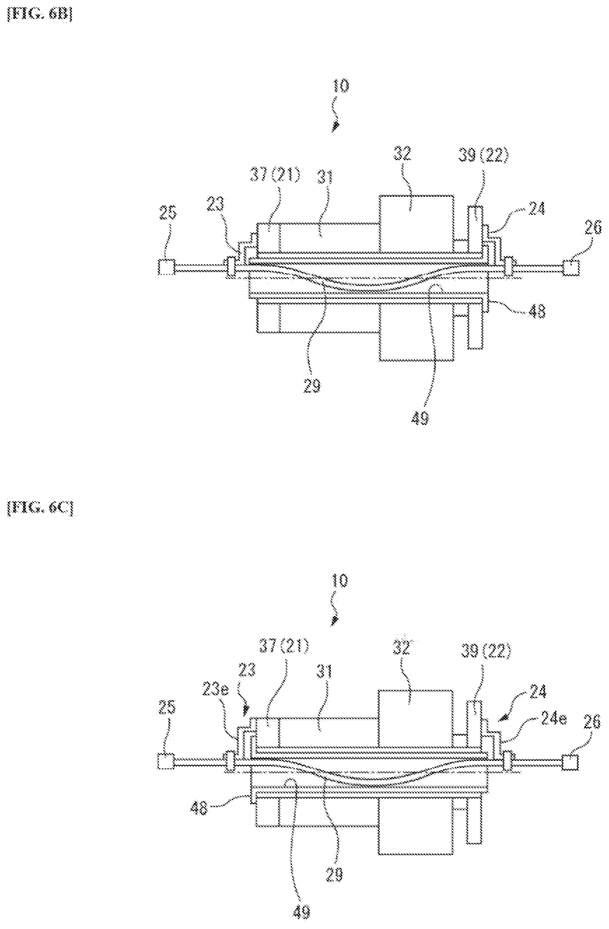

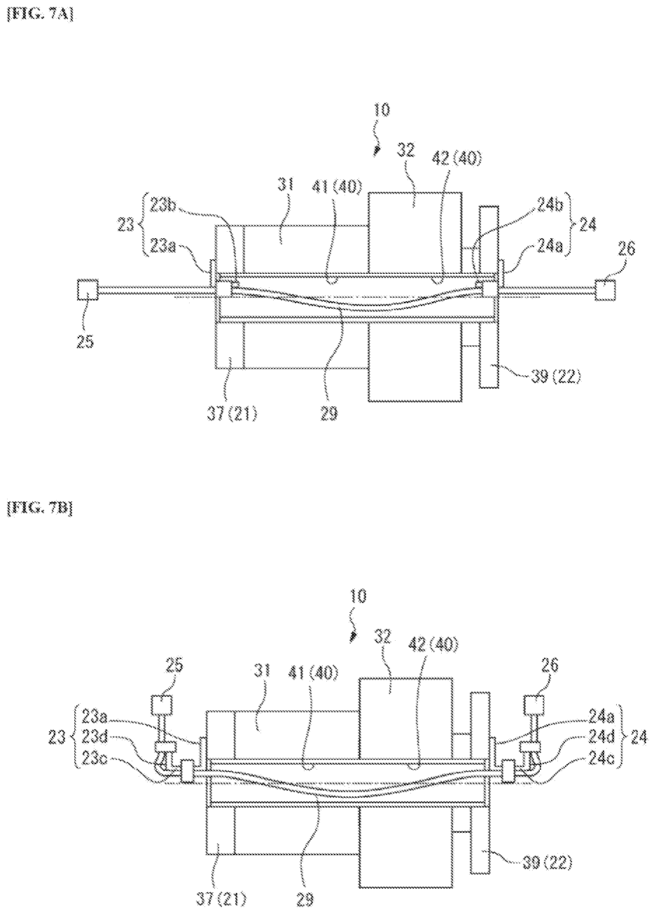

If the umbilical member 29 is not being twisted, the slack becomes the greatest. If such umbilical member 29 contacts the inside circumferential surface of the hollow part 40, at the time of operation of the actuator 10, there is a possibility of the umbilical member 29 breaking. FIG. 6A is a cross-sectional view of an integral umbilical member type actuator in a fourth embodiment. For the purpose of preventing damage of the umbilical member 29, in FIG. 6A, a protective tube 49 running through the inside of the actuator 10 and surrounding the umbilical member 29 to protect thereof is inserted into the hollow part 40 of the actuator 10.

As shown in FIG. 6B of a cross-sectional view of another integral umbilical member type actuator, a protective tube 49 may also be fastened through a flange 48 to an output side member, for example, the torque sensor 39 attached to the hollow speed reducer 32. If the actuator 10 includes a hollow speed reducer 32 and hollow motor 31, the protective tube 49 is preferably fastened to the hollow speed reducer 32 side rotating at a lower speed. The inside wall of the hollow shaft of the hollow motor 31 rotates at a high speed, so this is to avoid the umbilical member contacting the inside wall. By the protective tube 49 being fastened to an output shaft side of the hollow speed reducer 32, the inside wall of the protective tube rotates at a low speed the same as the output shaft, so the stress acting on the umbilical member 29 can be kept small. In the same way as when an actuator 10 includes an actuator body 20 and a motor adapter 30, the protective tube 49 is preferably fastened to the immovable motor adapter 30, but it may also be fastened to the output shaft side of the speed reducer 32.

Alternatively, as shown in FIG. 6C of a cross-sectional view of still another integral umbilical member type actuator, the protective tube 49 may be fastened through the flange 48 to the member of the input side, for example, to the outer circumference case of the hollow brake 37 attached to the hollow motor 31.

FIG. 7A is a cross-sectional view of an integral umbilical member type actuator in a fifth embodiment, while FIG. 7B is a cross-sectional view of another integral umbilical member type actuator in the fifth embodiment.

The first fastening part 23 and second fastening part 24 shown in FIG. 7A are respectively preferably substantially L-shape members provided with mounting members 23a, 24a to be attached to the end faces of the integral umbilical member type actuator 10 and first fastening members 23b, 24b vertical to the mounting members 23a. 24a and fastening the umbilical member 29. This is because by fastening the umbilical member at portions parallel to the rotational axis, only torsion acts on the umbilical member. Further, the fastening members 23b, 24b of the first fastening part 23 and second fastening part 24 extend toward the inside of the integral umbilical member type actuator 10. In this case, the fastening members 23b, 24b of the first fastening part 23 and second fastening part 24 are kept from being exposed at the outside of the integral umbilical member type actuator 10 and the integral umbilical member type actuator 10 can be made relatively small in size.

The first fastening part 23 and second fastening part 24 are not limited to such shapes. For example, in FIG. 3A, the respective fastening members 23b, 24b of the first fastening part 23 and second fastening part 24 extend in directions away from the integral umbilical member type actuator 10 and fasten the umbilical member 29 at the outside of the integral umbilical member type actuator 10.

Further, the first fastening part 23 and second fastening part 24 shown in FIG. 7B are substantially U-shaped members provided with mounting members 23a, 24a to be attached to the end faces of the integral umbilical member type actuator 10, first fastening members 23c, 24c vertical to the mounting members 23a, 24a and fastening the umbilical members 29, and second fastening members 23d, 24d verticals to the first fastening members 23c, 24c and fastening the umbilical member 29. As will be understood from FIG. 7B, the mounting members 23a, 24a and the second fastening members 23d, 24d are parallel with each other. Further, the first fastening part 23 and second fastening part 24 shown in FIG. 7B fasten the umbilical member 29 at the outside of the integral umbilical member type actuator 10.

Due to this, only torsion acts on the umbilical member. In addition, it becomes possible to keep the junction portions of the umbilical member from sticking out. Further, using the first fastening members 23c, 24c and second fastening members 23d, 24d, it is possible to change the direction of extension of the umbilical members 29 to a direction vertical to the axial direction of the integral umbilical member type actuator 10.

Further, in FIG. 7B, it is also possible to fasten the umbilical member 29 by only the second fastening members 23d, 24d. Alternatively, the shapes of the first fastening part 23 and second fastening part 24 may also be different from each other. For example, the first fastening part 23 may be a substantially L-shape (FIG. 7A) while the second fastening part 24 may also be a substantially U-shape (FIG. 7B). Furthermore, the fastening positions of the umbilical member 29 etc. may also be made to differ from each other at the first fastening part 23 and second fastening part 24. Furthermore, in the case where the robot is provided with a plurality of integral umbilical member type actuators 10, the shapes of the first fastening part 23 and second fastening part 24 may also differ between the actuator 10 at the base side of the robot and the other actuator 10 at the front end side of the robot.

Furthermore, in FIG. 6B and FIG. 6C, the substantially L-shape first fastening part 23 and second fastening part 24 respectively have step parts 23e, 24e. These step parts 23e, 24e can further secure slack of the umbilical member 29 and secure space enabling placement of the flange 48 of the protective tube 49.

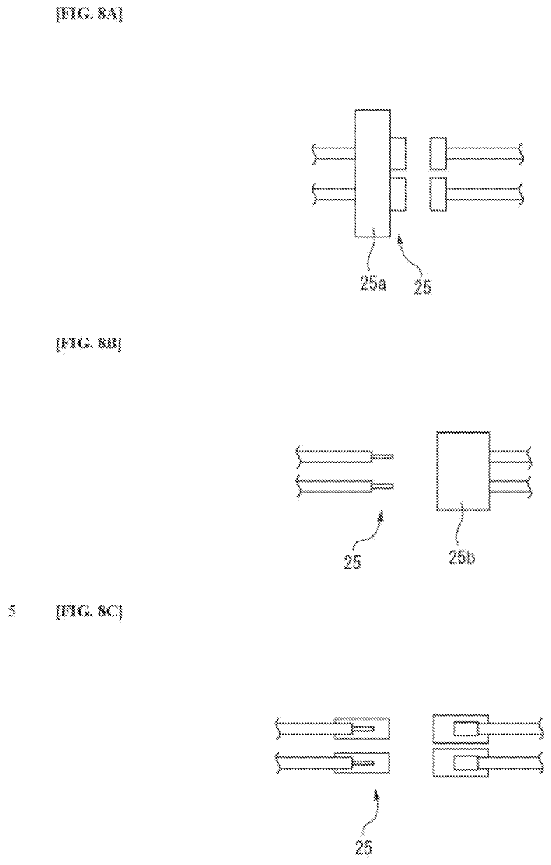

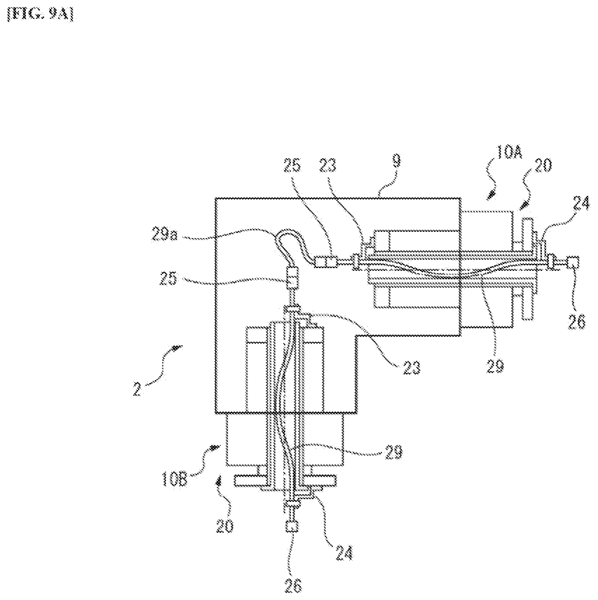

Furthermore, FIG. 8A to FIG. 8C are enlarged views of junction parts. The junction parts shown in FIG. 8A to FIG. 8C are the junction parts 25, but the junction parts 26 are also made similar. In FIG. 8A, a junction part 25 configured as a connector is shown and is connected to another connector. A junction part 25 itself is relatively heavy, so it is preferably mounted to another member, for example, a mounting member 25a provided at the robot arm or the robot arm itself. Due to this, the junction part 25 being shaken by operation of the robot is avoided. The mounting member 25a may also be an outer circumference case member forming the integral umbilical member type actuator 10.

In FIG. 8B, the wires of the stripped umbilical member 29 performs the role of the junction parts 25. Further, the junction parts 25 configured as line members are connected to a terminal block 25b by the screw type or clamp type etc. Note that, the terminal block 25b may also be attached to another member, for example, the robot arm etc. Furthermore, in FIG. 8C, junction parts 25 configured as bar terminals are shown and may be connected to other bar terminals. In FIG. 8B and FIG. 8C, the junction parts 25 themselves can be made light in weight, so it will be understood that the junction parts 25 become resistant to shaking due to operation of the robot.

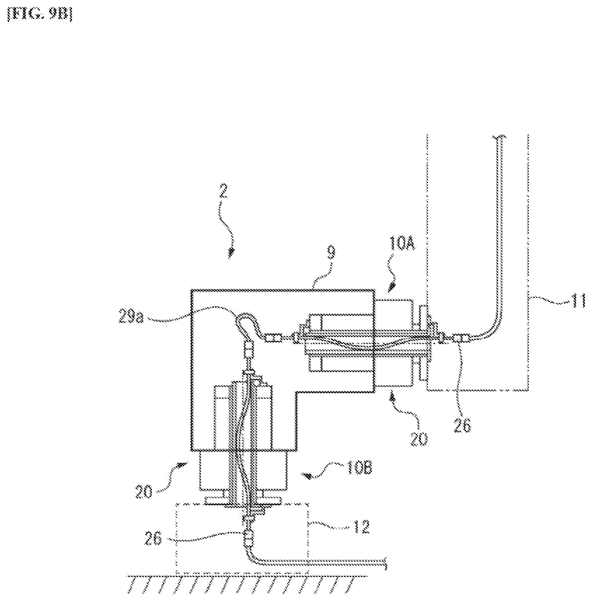

FIG. 9A is a cross-sectional view of a unit including an integral umbilical member type actuator in another embodiment, while FIG. 9B is another cross-sectional view of a unit including an integral umbilical member type actuator in another embodiment. In FIG. 9A, two integral umbilical member type actuators 10A, 10B similar to the above-mentioned integral umbilical member type actuator 10 are arranged inside the housing 9. The directions of extension of the rotational axes of the integral umbilical member type actuators 10A, 10B are perpendicular to each other. Further, the first junction part 25 of the integral umbilical member type actuator 10A and the first junction part 25 of the integral umbilical member type actuator 10B are respectively connected to the junction parts of additional umbilical member 29a. Note that, the unit 2 may also be one where the directions of extension of the rotational axes of the integral umbilical member type actuators 10A, 10B form a predetermined angle including 180°.

Furthermore, the actuator body 20 side of the integral umbilical member type actuator 10A has the first link 11 attached to it and the actuator body 20 side of the integral umbilical member type actuator 10A has the second link 12 attached to it. In FIG. 9B, the second link 12 is set on the floor part. In the cases shown in FIG. 9A and FIG. 9B as well, in the same way as explained before, needless to say a high reliability and long service life of the umbilical member are secured while assembly, reconfiguration, and maintenance become easy. Further, in FIG. 9A and FIG. 9B, the respective motor sides of the actuators 10A, 10B are joined with the housing 9 to form an integral unit 2 (dual axis actuator). However, the movable member 22 (shaft) or torque sensor 39 side of at least one of the actuators 10A, 10B may also be joined with the housing 9 to form an integral unit 2 (dual axis actuator). Furthermore, a robot 1 including at least one of the above-mentioned integral umbilical member type actuators 10, 10A, 10B and a robot including the unit 2 are also included in the scope of the present disclosure.

### Aspects of Disclosure

According to a first aspect, there is provided an integral umbilical member type actuator (10) comprising at least one umbilical members (29) extending running through an inside of the actuator, at least one first junction part (25) positioned at one end side of the actuator and being connected to one ends of the umbilical members, at least one second junction part (26) positioned at the other end side of the actuator and being connected to the other ends of the umbilical members, a first fastening part (23) fastening the umbilical members to the actuator between the first junction part and the second junction part, and a second fastening part (24) fastening the umbilical members to the actuator, lengths of the umbilical members between the first fastening part and the second fastening part being made longer than a shortest distance between the first fastening part and the second fastening part.

According to a second aspect, in the first aspect, lengths of the umbilical members between the first fastening part and the second fastening part are made longer than a shortest distance between the first fastening part and the second fastening part in the state where an output shaft of the actuator has rotated clockwise or counterclockwise to a maximum rotational angle thereof.

According to a third aspect, in the first or second aspect, the umbilical members are arranged to run at least partially on a center axis of the actuator or a line parallel to the center axis.

According to a fourth aspect, in any one of the first to third aspects, a motor (28) attached to a corner part of one end of the actuator is further comprised.

According to a fifth aspect, in the fourth aspect, a servo driver (27) controlling the motor is arranged at the actuator or at its vicinity.

According to a sixth aspect, in any one of the first to third aspects, the actuator includes a hollow motor (31) and a hollow speed reducer (32) coupled coaxially with the hollow motor.

According to a seventh aspect, in the sixth aspect, a servo driver (27) controlling the hollow motor is arranged at the actuator or at its vicinity.

According to an eighth aspect, in the sixth aspect, the actuator further comprises a hollow brake (37) arranged coaxially with the hollow motor.

According to a ninth aspect, in any one of the first to eighth aspects, a force detector (39) detecting a force acting on an output shaft of the actuator is included.

According to a 10th aspect, in any one of the first to ninth aspects, the actuator is provided with a protective tube (49) running through the inside of the actuator and surrounding the umbilical members, the protective tube being supported only at the one end or the other end of the actuator.

According to an 11th aspect, there is provided a unit comprising a first integral umbilical member type actuator according to any one of the first to 10th aspects and a second integral umbilical member type actuator according to any one of the first to 10th aspects, a direction of extension of a rotational axis of the first integral umbilical member type actuator and a direction of extension of a rotational axis of the second integral umbilical member type actuator forming a predetermined angle.

According to a 12th aspect, there is provided a robot including at least one actuator according to any one of the first to 10th aspects.

According to a 13th aspect, there is a provided a robot including a unit of the 11th aspect.

Above, embodiments of the present disclosure were explained, but persons skilled in the art will understand that various corrections and changes may be made without departing from the scope of disclosure of the later explained claims. Further, suitable combinations of several of the above-mentioned embodiments are also included in the scope of the present disclosure.

### REFERENCE SIGNS LIST

1 robot
2 unit
9 housing
10, 10A, 10B integral umbilical member type actuator
11 first link
12 second link
20 actuator body
21 fastened part
22 movable part
23 first fastening part
23a, 24a mounting member
24 second fastening part
23b, 24b fastening member
23c, 24c first fastening member
23d, 24d second fastening member
23e, 24e step part
25 first junction part
26 second junction part
27 servo driver
28 solid drive motor
29, 29a umbilical member
29a to 29d points
30 motor adapter
31 hollow motor
32 hollow speed reducer
37 hollow brake
39 torque sensor (force detector)
40 hollow part
41, 42 hollow part
48 flange
49 protective tube

1. An integral umbilical member type actuator comprising:
at least one umbilical members extending running through an inside of the actuator,
at least one first junction part positioned at one end side of the actuator and being connected to one end of the umbilical members,
at least one second junction part positioned at the other end side of the actuator and being connected to the other end of the umbilical members,
a first fastening part fastening the umbilical members to the actuator between the first junction part and the second junction part, and
a second fastening part fastening the umbilical members to the actuator,
lengths of the umbilical members between the first fastening part and the second fastening part being made longer than a shortest distance between the first fastening part and the second fastening part.

2. The integral umbilical member type actuator according to claim 1, wherein lengths of the umbilical members between the first fastening part and the second fastening part are made longer than a shortest distance between the first fastening part and the second fastening part in the state where an output shaft of the actuator has rotated clockwise or counterclockwise to a maximum rotational angle thereof.

3. The integral umbilical member type actuator according to claim 1, wherein the umbilical members are arranged to run at least partially on a center axis of the actuator or a line parallel to the center axis.

4. The integral umbilical member type actuator according to claim 1, further comprising a motor attached to a corner part of one end of the actuator.
